(19) United States
(12) Patent Application Publication
(10) Pub. No.: US 2023/0057014 A1
(43) Pub. Date: Feb. 23, 2023

(54) Method of Forming and Controlling Morphology of Cracks in Silicon Dioxide Film

(71) Applicant: Zhihong Liu, San Marcos, TX (US)

(72) Inventor: Zhihong Liu, San Marcos, TX (US)

(73) Assignee: 2M Technology, LLC, Austin, TX (US)

(21) Appl. No.: 17/406,764

(22) Filed: Aug. 19, 2021

(51) Int. Cl. B05D 3/02; C23C 30/00; C01B 33/141; C01B 33/148; C09D 1/00; B05D 3/00

(52) U.S. Cl. CPC B05D 3/0254; C23C 30/00; C01B 33/141; C01B 33/148; C09D 1/00; B05D 3/007; B05D 2202/00; B05D 2203/30; B05D 2201/02; B05D 2401/20; B05D 2430/00; B05D 2350/60; B82Y 40/00

(57) ABSTRACT

Methods for forming and controlling morphology cracks in silicon dioxide (SiO₂) film comprising: preparing SiO₂precursor solution comprising solvent, precursor of SiO₂, precursor of metal oxide nanocrystals, water, and acid; coating the solution onto substrate; drying the solution atop the substrate at a temperature between about 20° C. to 100° C. between 1 minute to 24 hours to form SiO₂ film having uniformly dispersed metal oxide nanocrystals, wherein shorter drying times yield substantially spherical shaped metal oxide nanocrystals and longer drying times yield rod and disc shaped metal oxide nanocrystals; and thermally treating the SiO₂ film between about 60° C. to 500° C. between 1 minute to 24 hours to form cracked mesh SiO₂ film, wherein two cracks initiate from rod shaped metal oxide nanocrystals, three to four cracks initiate from spherical shaped metal oxide nanocrystals, and four or more cracks initiate from disc shaped metal oxide nanocrystals. Other embodiments are described and claimed.

### I. BACKGROUND

The invention relates generally to the field of controlling the morphology of cracks in silicon dioxide film. More particularly, the invention relates to a method for forming and controlling morphology of cracks in silicon dioxide film by controlling the composition of the coating solution, the drying process, and the thermal treatment process. The cracked silicon dioxide film may be used as substrate for controlled cell culture and a template for the fabrication of a metal mesh.

### II. SUMMARY

In one respect, disclosed is a method for forming and controlling morphology of cracks in silicon dioxide film, the method comprising: preparing a silicon dioxide precursor solution, wherein the silicon dioxide precursor solution comprises a solvent, a precursor of silicon dioxide, a precursor of metal oxide nanocrystals, water, and an acid as a catalyst; coating the silicon dioxide precursor solution onto a substrate; drying the silicon dioxide precursor solution atop the substrate in ambient air, with blown air, and/or with blown nitrogen at a drying temperature between about 20° C. to 100° C. for drying times between 1 minute to 24 hours to form a silicon dioxide film having uniformly dispersed metal oxide nanocrystals, wherein shorter drying times yield substantially spherical, ball shaped metal oxide nanocrystals and wherein longer drying times yield rod shaped and disc shaped metal oxide nanocrystals; and thermally treating the silicon dioxide film at a thermally treating temperature between about 60° C. to 500° C. for thermally treating times between 1 minute to 24 hours to form a cracked mesh of silicon dioxide film, wherein approximately two cracks are initiated from each rod shaped metal oxide nanocrystal, wherein approximately three to four cracks are initiated from each substantially spherical, ball shaped metal oxide nanocrystal, and wherein approximately four or more cracks are initiated from each disc shaped metal oxide nanocrystal.

In another respect, disclosed is a method for forming and controlling morphology of cracks in silicon dioxide film, the method comprising: preparing a silicon dioxide precursor solution, wherein the silicon dioxide precursor solution comprises a solvent, a precursor of silicon dioxide, a precursor of metal oxide nanocrystals, water, a ligand, and an acid as a catalyst; coating the silicon dioxide precursor solution onto a substrate; drying the silicon dioxide precursor solution atop the substrate in ambient air, with blown air, and/or with blown nitrogen at a drying temperature between about 20° C. to 100° C. for drying times between 1 minute to 24 hours to form a silicon dioxide film having uniformly dispersed metal oxide nanocrystals, wherein shorter drying times yield substantially spherical, ball shaped metal oxide nanocrystals and wherein longer drying times yield rod shaped and disc shaped metal oxide nanocrystals; and thermally treating the silicon dioxide film at a thermally treating temperature between about 60° C. to 500° C. for thermally treating times between 1 minute to 24 hours to form a cracked mesh of silicon dioxide film, wherein approximately two cracks are initiated from each rod shaped metal oxide nanocrystal, wherein approximately three to four cracks are initiated from each substantially spherical, ball shaped metal oxide nanocrystal, and wherein approximately four or more cracks are initiated from each disc shaped metal oxide nanocrystal.

In another respect, disclosed is a method for forming and controlling morphology of cracks in silicon dioxide film, the method comprising: preparing a silicon dioxide precursor solution, wherein the silicon dioxide precursor solution comprises a solvent, a precursor of silicon dioxide, a precursor of metal oxide nanocrystals, water, and an acid as a catalyst; coating the silicon dioxide precursor solution onto a substrate; drying the silicon dioxide precursor solution atop the substrate in ambient air, with blown air, and/or with blown nitrogen at a drying temperature between about 20° C. to 100° C. for drying times between 1 minute to 24 hours to form a silicon dioxide film having uniformly dispersed metal oxide nanocrystals, wherein shorter drying times yield substantially spherical, ball shaped metal oxide nanocrystals and wherein longer drying times yield rod shaped and disc shaped metal oxide nanocrystals; and thermally treating the silicon dioxide film at a thermally treating temperature between about 60° C. to 500° C. for thermally treating times between 1 minute to 24 hours to form a cracked mesh of silicon dioxide film, wherein approximately two cracks are initiated from each rod shaped metal oxide nanocrystal, wherein approximately three to four cracks are initiated from each substantially spherical, ball shaped metal oxide nanocrystal, wherein approximately four or more cracks are initiated from each disc shaped metal oxide nanocrystal; depositing a metal film onto the silicon dioxide film and into cracks of the cracked mesh of silicon dioxide film; and performing a lift-off of the silicon dioxide film to leave a metal-mesh atop the substrate.

In yet another respect, disclosed is a method for forming and controlling morphology of cracks in silicon dioxide film, the method comprising: preparing a silicon dioxide precursor solution, wherein the silicon dioxide precursor solution comprises a solvent, a precursor of silicon dioxide, a precursor of metal oxide nanocrystals, water, a ligand, and an acid as a catalyst; coating the silicon dioxide precursor solution onto a substrate; drying the silicon dioxide precursor solution atop the substrate in ambient air, with blown air, and/or with blown nitrogen at a drying temperature between about 20° C. to 100° C. for drying times between 1 minute to 24 hours to form a silicon dioxide film having uniformly dispersed metal oxide nanocrystals, wherein shorter drying times yield substantially spherical, ball shaped metal oxide nanocrystal and wherein longer drying times yield rod shaped and disc shaped metal oxide nanocrystals; and thermally treating the silicon dioxide film at a thermally treating temperature between about 60° C. to 500° C. for thermally treating times between 1 minute to 24 hours to form a cracked mesh of silicon dioxide film, wherein approximately two cracks are initiated from each rod shaped metal oxide nanocrystal, wherein approximately three to four cracks are initiated from each substantially spherical, ball shaped metal oxide nanocrystal, wherein approximately four or more cracks are initiated from each disc shaped metal oxide nanocrystal; depositing a metal film onto the silicon dioxide film and into cracks of the cracked mesh of silicon dioxide film; and performing a lift-off of the silicon dioxide film to leave a metal-mesh atop the substrate.

Numerous additional embodiments are also possible.

### III. BRIEF DESCRIPTION OF THE DRAWINGS

Other objects and advantages of the invention may become apparent upon reading the detailed description and upon reference to the accompanying drawings.

FIG. 1 is a cross-sectional illustration of a film of a solution deposited on a substrate, wherein the solution comprises silicon dioxide sol and a second metal oxide ingredient, in accordance with some embodiments.

FIG. 2 is a cross-sectional illustration of the dried film of FIG. 1 resulting in uniformly dispersed rod shaped nanocrystals dispersed in the silicon dioxide film, in accordance with some embodiments.

FIG. 3 is a cross-sectional illustration of the dried film of FIG. 1 resulting in uniformly dispersed ball shaped nanocrystals dispersed in the silicon dioxide film, in accordance with some embodiments.

FIG. 4 is a cross-sectional illustration of the dried film of FIG. 1 resulting in uniformly dispersed disk shaped nanocrystals dispersed in the silicon dioxide film, in accordance with some embodiments.

FIG. 5 is a top-view illustration of the cracks generated by annealing the silicon dioxide film of FIG. 2 comprising rod shaped metal oxide nanocrystals, in accordance with some embodiments.

FIG. 6 is a top-view illustration of the cracks generated by annealing the silicon dioxide film of FIG. 3 comprising ball shaped metal oxide nanocrystals, in accordance with some embodiments.

FIG. 7 is a top-view illustration of the cracks generated by annealing the silicon dioxide film of FIG. 4 comprising disk shaped metal oxide nanocrystals, in accordance with some embodiments.

FIGS. 8A, 8B, 8C, and 8D are cross-sectional illustrations of the steps in fabricating a transparent conductive film using the cracked mesh of silicon dioxide, in accordance with some embodiments.

FIG. 9 is a block diagram illustrating a method for forming and controlling morphology of cracks in silicon dioxide film atop a substrate and using the silicon dioxide film as a mask for the fabrication of a nano-metal mesh atop the substrate, in accordance with some embodiments.

While the invention is subject to various modifications and alternative forms, specific embodiments thereof are shown by way of example in the drawings and the accompanying detailed description. It should be understood, however, that the drawings and detailed description are not intended to limit the invention to the particular embodiments. This disclosure is instead intended to cover all modifications, equivalents, and alternatives falling within the scope of the present invention as defined by the appended claims.

### IV. DETAILED DESCRIPTION

One or more embodiments of the invention are described below. It should be noted that these and any other embodiments are exemplary and are intended to be illustrative of the invention rather than limiting. While the invention is widely applicable to different types of systems, it is impossible to include all of the possible embodiments and contexts of the invention in this disclosure. Upon reading this disclosure, many alternative embodiments of the present invention will be apparent to persons of ordinary skill in the art.

Silicon dioxide film formed with sol-gel technique has been used for dielectric layers, planarization layers, cap layers, electronic packaging, implant barrier mask, multilayer resist patterning, and dopant diffusion sources in the semiconductor industry. Thick silicon dioxide films tend to crack due to internal stresses and are detrimental for these applications. Several methods have been used for avoiding the film cracking such as using polysiloxane type precursor instead of silicate type precursor, using chemical additives that modify the surface tension of the interstitial liquid during the drying process of the film, and reducing film stress by using a substrate with the thermal expansion coefficient matching that of silicon dioxide film. The cracks, which the semiconductor industry tries to avoid, may be used as a substrate for controlled cell culture or as a template for the fabrication of metal mesh atop a substrate. The use of cracks as a substrate for controlled cell culture is described in detail in U.S. Patent Application 20040063199A1, entitled “Patterning nanofeatures over large areas.” The use of cracks as a template for the fabrication of metal mesh atop a substrate is described in detail in U.S. Pat. No. 7,172,822 B2, entitled “Network conductor and its production method and use,” and U.S. Patent Application 20140326697A1, entitled “Conductive transparent film and method for making same.” Using cracks as a template has the benefit of low cost, availability for large size substrates, and possibility for feature size as small as 10 nanometers. The cracks may be generated by several methods, such as cracking during the drying process of silicon dioxide film, cracking due to the mismatch of thermal expansion coefficient between the silicon dioxide film and the substrate, and cracking by mechanical forces. The cracks generated by these methods usually distribute in the film randomly and non-uniformly. Additionally, the morphology of the cracks in silicon dioxide film is not well controlled in all these methods, especially for small feature cracks. The crack in a silicon dioxide film is initiated at the stress concentration position in the film. In order to get a uniformly distributed and well-controlled morphology of cracks in silicon dioxide film, the stress concentration position should be uniformly distributed in the silicon dioxide film. The invention disclosed herein provides a method for forming a silicon dioxide film on a substrate with metal oxide nanocrystals uniformly dispersed in the silicon dioxide film to control the morphology of cracks in the silicon dioxide film. In order to avoid the aggregation of the metal oxide nanocrystals, the metal oxide nanocrystals are formed in-situ in the drying process of the silicon dioxide film.

The preparation of silicon dioxide thin films with sol-gel method is based on converting the silicon dioxide precursor solutions to gels after chemical reactions of hydrolysis and polycondensation of sols. The silicon dioxide precursor solutions usually contain silicon alkoxide such as tetraethoxysilane (TEOS), chlorosilane, and/or tetramethoxysilane (TMOS); solvent such as acetone, 1-butanol, 2-butanol, chlorobenzene, chloroform, dimethyl-formamide (DMF), dimethyl sulfoxide (DMSO), ethanol, ethyl acetate, ethylene glycol, glycerin, heptane, hexane, and/or methanol; water; and acid such as formic acid, hydrochloric acid, hydrobromic acid, sulfuric acid, nitric acid, phosphoric acid, chromic acid, boric acid, acetic acid, citric acid, gluconic acid, lactic acid, oxalic acid, and/or tartaric acid. The properties of sol-gel silicon dioxide thin films are governed by the preparation conditions such as sol composition, film application process, and heat treatment conditions. The concentration of water and acid in the solution can affect the relative rates of hydrolysis and condensation. The rates of condensation and evaporation during deposition, largely define the properties of silicon dioxide film.

Metal Oxide nanocrystals can be synthesized by thermolysis, solvothermal, and hydrolysis methods. The temperature used in thermolysis and solvothermal methods is usually higher than 100° C. Hydrolysis method can take place at room temperature, so it is suitable for forming metal oxide nanocrystals in the silicon dioxide film. Organometallic, metal-amide, and/or metal salt are used as precursors for hydrolysis routes to metal oxide nanocrystals. The size, morphology, and surface structure of the resulting metal oxide nanocrystals may be controlled by the solvent, concentration of the metal precursor, concentration of water, the ligand if used, and temperature. Ligands, such as octylamine, may be used as surfactants to cover the surface of the metal oxide nanocrystals to avoid the aggregation of the metal oxide nanocrystals. In the metal oxide nanocrystals synthesis process, nucleation is followed by particle growth until the supersaturation of precursor is depleted. Coarsening and aggregation dominate the process after nucleation and particle growth. Coarsening involves the growth of larger crystals at the expense of smaller crystals. Aggregation is dependent on surface chemistry. The aggregation of metal oxide nanocrystals should be avoided in this invention. Usually the coarsening process is controlled by the diffusion of the metal ions. The coarsening process is stopped by controlling the metal ions' diffusion coefficient in the coating process of silicon dioxide film. Larger and fewer metal oxide nanocrystals will be formed in the silicon dioxide film with higher metal ions' diffusion coefficient. Smaller and more metal oxide nanocrystals will be formed in the silicon dioxide film with lower metal ions' diffusion coefficient. The shape of the nanocrystals also can be controlled by the coarsening process. Low energy crystal facets will dominate the nanocrystal surface in a relative long coarsening process.

After depositing the solution with precursors of silicon dioxide and metal oxide onto the substrate, the solvent is evaporated during the drying process and the concentration of the precursors is increased. With careful design of the concentration of the precursors of silicon dioxide and metal oxide, metal oxide nanocrystal nucleates first when the concentration of the precursor of metal oxide is higher than the nucleation point. Different size metal oxide nanocrystals are achieved by controlling the solvent evaporation speed. Due to lacking enough time for coarsening, smaller size metal oxide nanocrystals are formed with higher solvent evaporation speed. Larger size metal oxide nanocrystals are formed with lower solvent evaporation speed. Silicon dioxide film is formed after the metal oxide nanocrystal nucleates. Therefore, a silicon dioxide film on a substrate with metal oxide nanocrystals uniformly dispersed in the silicon dioxide film may be formed by carefully controlling the precursor of the solution and the coating process.

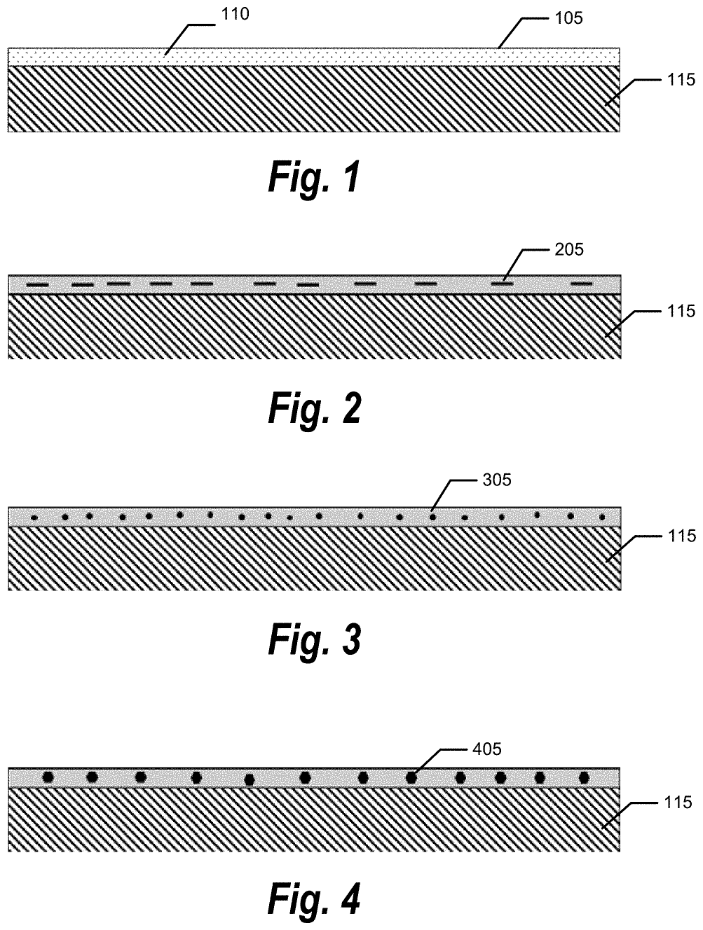

FIG. 1 is a cross-sectional illustration of a film of a solution deposited on a substrate, wherein the solution comprises silicon dioxide sol and a second metal oxide ingredient, in accordance with some embodiments.

FIG. 2 is a cross-sectional illustration of the dried film of FIG. 1 resulting in uniformly dispersed rod shaped nanocrystals dispersed in the silicon dioxide film, in accordance with some embodiments.

FIG. 3 is a cross-sectional illustration of the dried film of FIG. 1 resulting in uniformly dispersed ball shaped nanocrystals dispersed in the silicon dioxide film, in accordance with some embodiments.

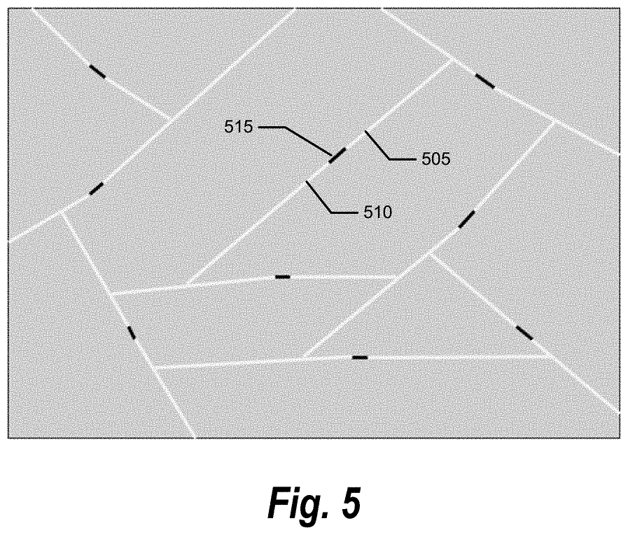

FIG. 4 is a cross-sectional illustration of the dried film of FIG. 1 resulting in uniformly dispersed disk shaped nanocrystals dispersed in the silicon dioxide film, in accordance with some embodiments.

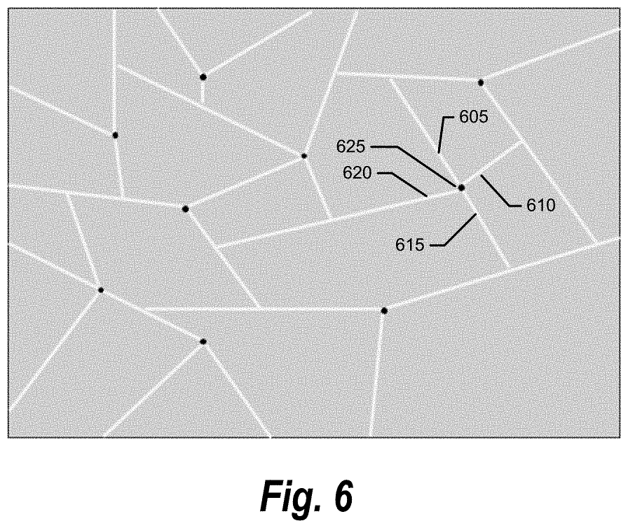

FIG. 5 is a top-view illustration of the cracks generated by annealing the silicon dioxide film of FIG. 2 comprising rod shaped metal oxide nanocrystals, in accordance with some embodiments.

FIG. 6 is a top-view illustration of the cracks generated by annealing the silicon dioxide film of FIG. 3 comprising ball shaped metal oxide nanocrystals, in accordance with some embodiments.

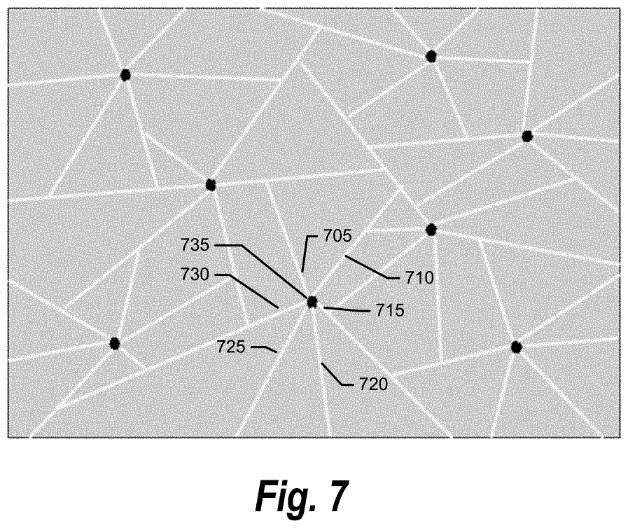

FIG. 7 is a top-view illustration of the cracks generated by annealing the silicon dioxide film of FIG. 4 comprising disk shaped metal oxide nanocrystals, in accordance with some embodiments.

A cracked mesh in silicon dioxide film, as illustrated in FIG. 5, FIG. 6, and FIG. 7, may be formed by depositing a silicon dioxide film 105 with metal oxide nanocrystals 110 uniformly dispersed in the silicon dioxide film on a substrate 115 and subsequent thermal treatment of the deposited silicon dioxide film. The silicon dioxide precursor solution for coating the silicon dioxide film comprises a solvent, a precursor of silicon dioxide, a precursor of metal oxide nanocrystals, water, and an acid as a catalyst. The solvent comprises at least one of: acetone, 1-butanol, 2-butanol, chlorobenzene, chloroform, dimethylformamide (DMF), dimethyl sulfoxide (DMSO), ethanol, ethyl acetate, ethylene glycol, glycerin, heptane, hexane, methanol, N-methyl-2-pyrrolidinone (NMP), 1-propanol, 2-propanol, tetrahydrofuran (THF), toluene, and combinations thereof. The precursor of silicon dioxide comprises tetraethoxysilane (TEOS), chlorosilane, and/or tetramethoxysilane (TMOS). The precursor of metal oxide nanocrystals comprises organometallic, metal-amide, and/or metal salt of corresponding metal oxide. The metal oxide comprises at least one of: Li₂O, MgO, FeO, Fe₂O₃, MnO, CoO, Co₂O₃, CuO, ZnO, V₂O₅, Cr₂O₃, In₂O₃, and SnO. The acid comprises at least one of: formic acid, hydrochloric acid, hydrobromic acid, sulfuric acid, nitric acid, phosphoric acid, chromic acid, boric acid, acetic acid, citric acid, gluconic acid, lactic acid, oxalic acid, tartaric acid, and combinations thereof. The concentration of the acid is selected to maintain a stable silicon dioxide sol. In some embodiments, the concentration of the acid ranges from 0.01 mM to 0.1 M. The pH value of the solution is also selected to maintain a stable silicon dioxide sol. In some embodiments, the pH value of the solution ranges from 0.1 to 6. The concentration of water is selected to maintain a water concentration of 0.1 μM to 0.1 mM. The concentration of precursor of silicon dioxide is selected by the thickness of the silicon dioxide film. The thickness of the silicon dioxide film ranges from 50 nm to 5 μm. The concentration of precursor of silicon dioxide ranges from 0.01 wt % to 5 wt %. The concentration of the metal oxide precursor is selected by the size and density of nanocrystals in the silicon dioxide film. The concentration of the metal oxide precursor ranges from 0.001 wt % to 0.1 wt %. Silicon dioxide precursor solutions are prepared by mixing the appropriate amount of solvent, silicon dioxide precursor, metal oxide precursor, water, and acid. After a period of stirring, the solution is ready for coating. The stirring time ranges from 1 minute to 24 hours.

The silicon dioxide precursor solution is coated to a substrate by dip coating, spin coating, spraying, knife-over-roll coating, Mayer rod coating, gravure coating, or slot-die coating. The substrate 115 comprises a metal, plastic, semiconductor, or ceramic. The metal comprises at least one of: iron, aluminum, molybdenum, chromium, silver, copper, gold, tin, titanium, indium, platinum, nickel, cobalt, palladium, and an alloy combination thereof. The plastic comprises at least one of: polyethylene terephthalate (PET), polyimide (PI), cellulose, polyester, polyethylene, polyolefin, polycarbonate, laminates thereof, composites thereof, and combinations thereof. The semiconductor comprises at least one of: silicon, germanium, gallium arsenide, cadmium selenide, and silicon carbide. The ceramic comprises at least one of: zirconium dioxide, zinc oxide, titanium carbide, silicon nitride, porcelain, magnesium diboride, boron nitride, and boron oxide. The drying process of the silicon dioxide film is carefully controlled. The silicon dioxide film may be dried in ambient air, blown air, and/or blown nitrogen. The drying temperature is kept between about 20° C. to 100° C. Larger and fewer metal oxide nanocrystals are formed in silicon dioxide film by using a longer drying time. The drying time of the film ranges from 1 minute to 24 hours. Different shaped metal oxide nanocrystals are achieved depending on drying time. Shorter drying times result in substantially spherical, ball shaped metal oxide nanocrystals 305, as illustrated in FIG. 3. Longer drying times result in rod shaped 205 and disc shaped 405 metal oxide nanocrystals, as illustrated in FIG. 2 and FIG. 4, respectively.

After the initial drying time to yield metal oxide nanocrystals, the silicon dioxide film is subsequently thermally treated at a temperature between about 60° C. to 500° C. The thermal treatment time ranges from 1 minute to 24 hours. Cracks are initiated from the metal oxide nanocrystals. The quantity of cracks initiated from the metal oxide nanocrystals is determined by the shape of the nanocrystals. Usually two cracks, 505, 510 are initiated from each rod shaped nanocrystal 515, as illustrated in FIG. 5, three to four cracks, 605, 610, 615, 620 are initiated from each ball shaped nanocrystal 625, as illustrated in FIG. 6, and more than four cracks, 705, 710, 715, 720, 725, 730 are initiated from each disk shaped nanocrystal 735. The density of the cracks is determined by the density of metal oxide nanocrystals in the coated silicon dioxide film after the initial drying. The width of the cracks is determined by the thickness of the coated silicon dioxide film and the subsequent thermal treatment time. Thick silicon dioxide films and a longer thermal treatment time yield wider cracks.

In one exemplary embodiment, a cracked mesh of silicon dioxide is formed from a silicon dioxide film with zinc oxide nanocrystals. The chemicals used for the silicon dioxide precursor solution were tetraethoxysilane, formic acid, dicyclohexylzinc, octylamine, DI water, and acetone. 4 wt % of tetraethoxysilane and 0.01 wt % of dicyclohexylzinc were dissolved in 100 ml of acetone. After stirring the solution for 2 hours, 10 ml DI water, 2 ml octylamine, and several drops of formic acid were added to the solution. The pH of the solution was kept below 2. The solution was stirred at room temperature for another 2 hours. Two silicon wafers were thoroughly cleaned with acetone for 3 minutes, isopropyl alcohol for 3 minutes, and DI water for 3 minutes in an ultrasonic bath in separate runs to remove any contaminants and then dried with blowing nitrogen at room temperature. The solution was deposited onto the cleaned silicon wafers by spin coating at a speed of 2000 rpm for 2 minutes. One wafer was baked on a hotplate at 100° C. for 10 minutes while a second wafer was dried at room temperature for 24 hours. In the silicon dioxide film on the wafer that was baked at 100° C. for 10 minutes, ball shaped zinc oxide nanocrystals were formed. The thickness of silicon dioxide film was about 200 nm. The size of the zinc oxide nanocrystals were about 5 to 10 nm. Next, the wafer was baked in an oven at 150° C. for 4 hours to form cracks with a density of 1×10¹⁰/m² to 1×10¹²/m² in the silicon dioxide film. The width of the cracks was about 100 to 200 nm. In the silicon dioxide film on the wafer that was dried in room temperature for 24 hours, rod shaped zinc oxide nanocrystals were formed. The thickness of silicon dioxide film was about 200 nm. The diameter of the zinc oxide nanorods was about 5 to 10 nm, and the length of the zinc oxide nanorods was about 100 to 150 nm. Next, the wafer was baked in an oven at 150° C. for 4 hours to form cracks with a density of 1×10⁸/m² to 1×10¹⁰/m² in the silicon dioxide film. The width of the cracks was about 500 to 800 nm.

In another exemplary embodiment, a cracked mesh of silicon dioxide is formed from a silicon dioxide film with cobalt oxide nanocrystals. The chemicals used for the silicon dioxide precursor solution were tetraethoxysilane, hydrochloric acid, dicobaltoctacarbonyl, DI water, and ethanol. 3.5 wt % of tetraethoxysilane and 0.04 wt % of dicobaltoctacarbonyl were dissolved in 100 ml of ethanol. After stirring the solution for 2 hours, 8 ml DI water and several drops of hydrochloric acid were added to the solution. The pH of the solution was kept about 4. The solution was stirred at room temperature for another 4 hours. A piece of PET film, 4 inches by 3 feet, was thoroughly cleaned with acetone for 3 minutes, isopropyl alcohol for 3 minutes, and DI water for 3 minutes in an ultrasonic bath in separate runs to remove any contaminants and then dried with blowing nitrogen at room temperature. The solution was deposited onto the cleaned PET film by Mayer rod coating method. The film was subsequently dried at room temperature for 24 hours. Disc shaped cobalt oxide nanocrystals were formed in the silicon dioxide film. The thickness of silicon dioxide film was about 180 nm. Next, the film was baked in an oven at 150° C. for 4 hours to form cracks with a density of 1×10⁸/m² to 1×10¹⁰/m² in the silicon dioxide film. The width of the cracks was about 400 to 600 nm.

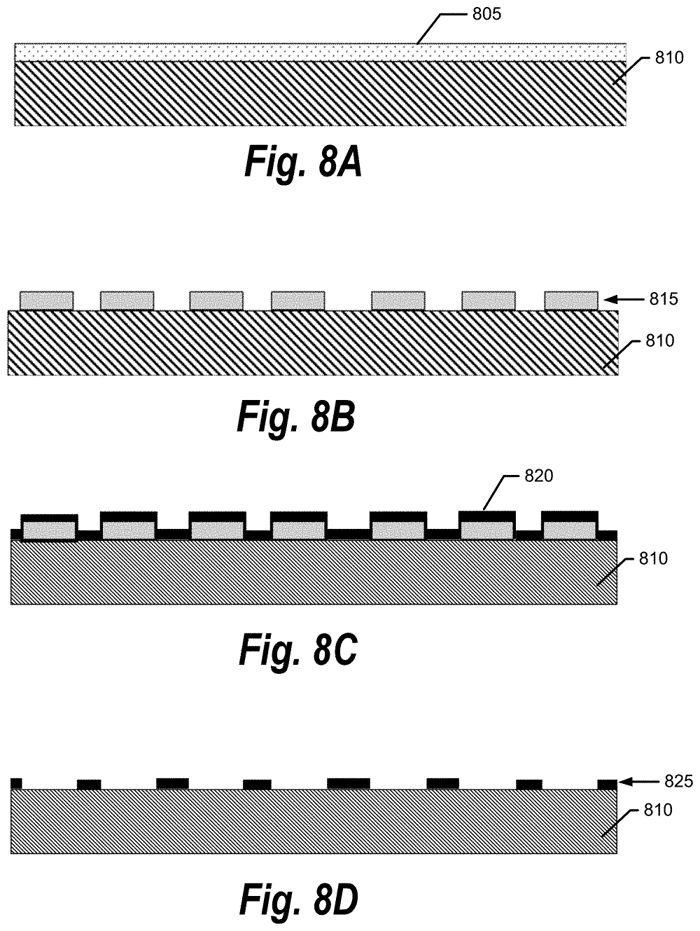

FIGS. 8A, 8B, 8C, and 8D are cross-sectional illustrations of the steps in fabricating a transparent conductive film using the cracked mesh of silicon dioxide, in accordance with some embodiments.

In some embodiments, the cracked mesh of silicon dioxide film may be used as a template to form a transparent conductive film. First, as shown in FIG. 8A, the silicon dioxide precursor solution 805 may be coated on a flexible substrate 810 by a roll-to-roll coating method. The substrate comprises any transparent and flexible film, such as polyethylene terephthalate (PET), polyimide (PI), cellulose, polyester, polyethylene, polyolefin, polycarbonate, flexible glass, laminates thereof, composites thereof, or combination thereof. The crack mesh 815, as shown in FIG. 8B, is formed on the substrate 810 by thermal treatment of the film 805. A metal film 820, as shown in FIG. 8C, is deposited onto the silicon dioxide film and into the cracks of the cracked mesh of silicon dioxide film. The metal of the metal film comprises silver, copper, gold, iron, nickel, cobalt, platinum, palladium, titanium, aluminum, chromium, molybdenum, or an alloy combination thereof. A lift-off of the silicon dioxide layer is performed from the substrate, resulting in a metal-mesh 825 atop the substrate 810, as shown in FIG. 8D. The resulting metal mesh may have optical transmission at 550 nm of at least 85% and a sheet resistance of no more than about 10 ohms/sq.

In one exemplary embodiment, a flexible transparent conductive film is made using a cracked mesh of silicon dioxide film as a template. First, a cracked mesh of silicon dioxide is formed from a silicon dioxide film with zinc oxide nanocrystals. The chemicals used for the silicon dioxide precursor solution were tetraethoxysilane, hydrochloric acid, dicyclohexylzinc, octylamine, DI water, acetone, methanol, and isopropyl alcohol. 4 wt % of tetraethoxysilane and 0.02 wt % of dicyclohexylzinc were dissolved in 100 ml acetone, 200 ml methanol, and 3.7 L isopropyl alcohol. After stirring the solution for 2 hours, 300 ml DI water, 20 ml octylamine and several drops of hydrochloric acid were added to the solution. The pH of the solution was kept about 2. The solution was stirred at room temperature for another 4 hours. A roll of pre-cleaned PET film of 4 inches wide was used as a substrate. The solution was deposited onto the PET film by slot-die coating method. The film was subsequently dried by blowing air at room temperature for 30 minutes. Ball shaped zinc oxide nanocrystals were formed in the silicon dioxide film. The thickness of silicon dioxide film was about 200 nm. The size of the zinc oxide nanocrystals were about 50 nm. Next, the film was baked in an oven at 150° C. for 4 hours to form cracks with a density of 1×10⁸/m² to 1×10¹⁰/m² in the silicon dioxide film. The width of the cracks was about 600 to 1000 nm. After baking, the film was etched by oxygen plasma for 1 minute and then a 300 nm thick silver film was deposited onto the silicon dioxide film and into the crack mesh. A lift-off of the silicon dioxide layer is performed by 5% hydrofluoric acid, resulting in the silver-mesh atop the PET substrate. The silver mesh had an optical transmission at 550 nm of about 87% and a sheet resistance of about 8 ohms/sq.

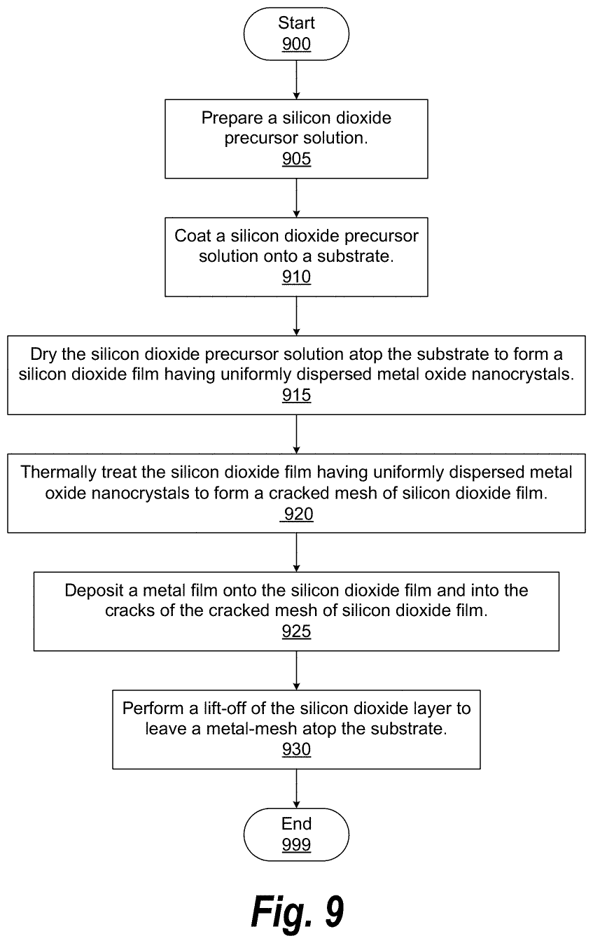

FIG. 9 is a block diagram illustrating a method for forming and controlling morphology of cracks in silicon dioxide film atop a substrate and using the silicon dioxide film as a mask for the fabrication of a nano-metal mesh atop the substrate, in accordance with some embodiments. In some embodiments, the method illustrated in FIG. 9 may be performed by the steps described and illustrated for FIGS. 1-8.

Processing begins at 900 whereupon at block 905 a silicon dioxide precursor solution is prepared, wherein the silicon dioxide precursor solution comprises a solvent, a precursor of silicon dioxide, a precursor of metal oxide nanocrystals, water, and an acid as a catalyst. The solvent comprises at least one of: acetone, 1-butanol, 2-butanol, chlorobenzene, chloroform, dimethylformamide (DMF), dimethyl sulfoxide (DMSO), ethanol, ethyl acetate, ethylene glycol, glycerin, heptane, hexane, methanol, N-methyl-2-pyrrolidinone (NMP), 1-propanol, 2-propanol, tetrahydrofuran (THF), toluene, and combinations thereof. The precursor of silicon dioxide comprises tetraethoxysilane (TEOS), chlorosilane, and/or tetramethoxysilane (TMOS). The precursor of metal oxide nanocrystals comprises organometallic, metal-amide, and/or metal salt of corresponding metal oxide. The metal oxide comprises at least one of: Li₂O, MgO, FeO, Fe₂O₃, MnO, CoO, Co₂O₃, CuO, ZnO, V₂O₅, Cr₂O₃, In₂O₃, and SnO. The acid comprises at least one of: formic acid, hydrochloric acid, hydrobromic acid, sulfuric acid, nitric acid, phosphoric acid, chromic acid, boric acid, acetic acid, citric acid, gluconic acid, lactic acid, oxalic acid, tartaric acid, and combinations thereof. The concentration of the acid is selected to maintain a stable silicon dioxide sol. In some embodiments, the concentration of the acid ranges from 0.01 mM to 0.1 M. The pH value of the solution is also selected to maintain a stable silicon dioxide sol. In some embodiments, the pH value of the solution ranges from 0.1 to 6. The concentration of water is selected to maintain a water concentration of 0.1 μM to 0.1 mM. The concentration of precursor of silicon dioxide is selected by the thickness of the silicon dioxide film. The thickness of the silicon dioxide film ranges from 50 nm to 5 μm. The concentration of precursor of silicon dioxide ranges from 0.01 wt % to 5 wt %. The concentration of the metal oxide precursor is selected by the size and density of nanocrystals in the silicon dioxide film. The concentration of the metal oxide precursor ranges from 0.001 wt % to 0.1 wt %. Silicon dioxide precursor solutions are prepared by mixing the appropriate amount of solvent, silicon dioxide precursor, metal oxide precursor, water, and acid. After a period of stirring, the solution is ready for coating. The stirring time ranges from 1 minute to 24 hours.

Next, at block 910, the silicon dioxide precursor solution is coated onto a substrate. The silicon dioxide precursor solution may be coated to the substrate by dip coating, spin coating, spraying, knife-over-roll coating, Mayer rod coating, gravure coating, or slot-die coating. The substrate comprises a metal, plastic, semiconductor, or ceramic. The metal comprises at least one of: iron, aluminum, molybdenum, chromium, silver, copper, gold, tin, titanium, indium, platinum, nickel, cobalt, palladium, and an alloy combination thereof. The plastic comprises at least one of: polyethylene terephthalate (PET), polyimide (PI), cellulose, polyester, polyethylene, polyolefin, polycarbonate, laminates thereof, composites thereof, and combinations thereof. The semiconductor comprises at least one of: silicon, germanium, gallium arsenide, cadmium selenide, and silicon carbide. The ceramic comprises at least one of: zirconium dioxide, zinc oxide, titanium carbide, silicon nitride, porcelain, magnesium diboride, boron nitride, and boron oxide.

Next at block 915, the silicon dioxide precursor solution atop the substrate is dried to form a silicon dioxide film having uniformly dispersed metal oxide nanocrystals. The drying process of the silicon dioxide film is carefully controlled. The silicon dioxide film may be dried in ambient air, blown air, and/or blown nitrogen. The drying temperature is kept between about 20° C. to 100° C. Larger and fewer metal oxide nanocrystals are formed in silicon dioxide film by using a longer drying time. The drying time of the film ranges from 1 minute to 24 hours. Different shaped metal oxide nanocrystals are achieved depending on drying time. Shorter drying times result in substantially spherical, ball shaped metal oxide nanocrystals. Longer drying times result in rod shaped and disc shaped metal oxide nanocrystals.

Subsequently, at block 920, the silicon dioxide film having uniformly dispersed metal oxide nanocrystals is thermally treated to form a cracked mesh of silicon dioxide film. The silicon dioxide film is thermally treated at a temperature between about 60° C. to 500° C. The thermal treatment time ranges from 1 minute to 24 hours. Cracks are initiated from the uniformly dispersed metal oxide nanocrystals. The quantity of cracks initiated from the metal oxide nanocrystals is determined by the shape of the nanocrystals. Approximately two cracks are initiated from each rod shaped nanocrystal, approximately three to four cracks are initiated from each ball shaped nanocrystal, and approximately four or more cracks are initiated from each disk shaped nanocrystal. The density of the cracks is determined by the density of metal oxide nanocrystals in the coated silicon dioxide film after the initial drying. The width of the cracks is determined by the thickness of the coated silicon dioxide film and the subsequent thermal treatment time. Thick silicon dioxide films and a longer thermal treatment time yield wider cracks.

In some embodiments, the method continues to block 925, where a metal film is deposited onto the silicon dioxide film and into the cracks of the cracked mesh of silicon dioxide film. The metal of the metal film comprises silver, copper, gold, iron, nickel, cobalt, platinum, palladium, titanium, aluminum, chromium, molybdenum, or an alloy combination thereof.

Next, at block 930, a lift-off of the silicon dioxide layer is performed from the substrate, resulting in a metal-mesh atop the substrate. The resulting metal mesh may have optical transmission at 550 nm of at least 85% and a sheet resistance of no more than about 10 ohms/sq. Processing subsequently ends at 999.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

The benefits and advantages that may be provided by the present invention have been described above with regard to specific embodiments. These benefits and advantages, and any elements or limitations that may cause them to occur or to become more pronounced are not to be construed as critical, required, or essential features of any or all of the claims. As used herein, the terms “comprises,” “comprising,” or any other variations thereof, are intended to be interpreted as non-exclusively including the elements or limitations which follow those terms. Accordingly, a system, method, or other embodiment that comprises a set of elements is not limited to only those elements, and may include other elements not expressly listed or inherent to the claimed embodiment.

While the present invention has been described with reference to particular embodiments, it should be understood that the embodiments are illustrative and that the scope of the invention is not limited to these embodiments. Many variations, modifications, additions, and improvements to the embodiments described above are possible. It is contemplated that these variations, modifications, additions, and improvements fall within the scope of the invention as detailed within the following claims.

1. A method of forming and controlling morphology of cracks in silicon dioxide film, the method comprising:
preparing a silicon dioxide precursor solution, wherein the silicon dioxide precursor solution comprises a solvent, a precursor of silicon dioxide, a precursor of metal oxide nanocrystals, water, and an acid as a catalyst;
coating the silicon dioxide precursor solution onto a substrate;
drying the silicon dioxide precursor solution atop the substrate in ambient air, with blown air, and/or with blown nitrogen at a drying temperature between about 20° C. to 100° C. for drying times between 1 minute to 24 hours to form a silicon dioxide film having uniformly dispersed metal oxide nanocrystals, wherein shorter drying times yield substantially spherical, ball shaped metal oxide nanocrystals and wherein longer drying times yield rod shaped and disc shaped metal oxide nanocrystals; and
thermally treating the silicon dioxide film at a thermally treating temperature between about 60° C. to 500° C. for thermally treating times between 1 minute to 24 hours to form a cracked mesh of silicon dioxide film, wherein approximately two cracks are initiated from each rod shaped metal oxide nanocrystal, wherein approximately three to four cracks are initiated from each substantially spherical, ball shaped metal oxide nanocrystal, and wherein approximately four or more cracks are initiated from each disc shaped metal oxide nanocrystal.

2. The method of claim 1, further comprising:
depositing a metal film onto the silicon dioxide film and into cracks of the cracked mesh of silicon dioxide film; and
performing a lift-off of the silicon dioxide film to leave a metal-mesh atop the substrate.

3. The method of claim 1, wherein the silicon dioxide precursor further comprises a ligand.

4. The method of claim 1, wherein the solvent comprises at least one of: acetone, 1-butanol, 2-butanol, chlorobenzene, chloroform, dimethylformamide, dimethyl sulfoxide, ethanol, ethyl acetate, ethylene glycol, glycerin, heptane, hexane, methanol, N-methyl-2-pyrrolidinone, 1-propanol, 2-propanol, tetrahydrofuran, toluene, and combinations thereof.

5. The method of claim 1, wherein the precursor of silicon dioxide comprises tetraethoxysilane, chlorosilane, and/or tetramethoxysilane.

6. The method of claim 1, wherein the precursor of silicon dioxide comprises a concentration ranging from 0.01 wt % to 5 wt %.

7. The method of claim 1, wherein the precursor of metal oxide nanocrystals comprises organometallic, metal-amide, and/or metal salt of corresponding metal oxide.

8. The method of claim 7, wherein the metal oxide comprises at least one of: Li₂O, MgO, FeO, Fe₂O₃, MnO, CoO, Co₂O₃, CuO, ZnO, V₂O₅, Cr₂O₃, In₂O₃, and SnO.

9. The method of claim 1, wherein the metal oxide precursor comprises a concentration ranging from 0.001 wt % to 0.1 wt %.

10. The method of claim 1, wherein the acid comprises at least one of: formic acid, hydrochloric acid, hydrobromic acid, sulfuric acid, nitric acid, phosphoric acid, chromic acid, boric acid, acetic acid, citric acid, gluconic acid, lactic acid, oxalic acid, tartaric acid, and combinations thereof.

11. The method of claim 1, wherein the silicon dioxide precursor solution comprises a pH value from 0.1 to 6.

12. The method of claim 1, wherein the substrate comprises a metal, a plastic, a semiconductor, or a ceramic.

13. The method of claim 12, wherein the metal comprises at least one of: iron, aluminum, molybdenum, chromium, silver, copper, gold, tin, titanium, indium, platinum, nickel, cobalt, palladium, and an alloy combination thereof.

14. The method of claim 12, wherein the plastic comprises at least one of: polyethylene terephthalate, polyimide, cellulose, polyester, polyethylene, polyolefin, polycarbonate, laminates thereof, composites thereof, and combination thereof.

15. The method of claim 12, wherein the semiconductor comprises at least one of: silicon, germanium, gallium arsenide, cadmium selenide, and silicon carbide.

16. The method of claim 12, wherein the ceramic comprises zirconium dioxide, zinc oxide, titanium carbide, silicon nitride, porcelain, magnesium diboride, boron nitride, and boron oxide.

17. The method of claim 1, wherein the water comprises a concentration ranging from 0.1 μM to 0.1 mM.

18. The method of claim 1, wherein the silicon dioxide film comprises a thickness ranging from 50 nm to 5 μM.

19. The method of claim 1, wherein the cracked mesh of silicon dioxide film comprises a crack density of 1×10¹⁰/m² to 1×10¹²/m² and a crack width from about 100 to 200 nm.

20. The method of claim 1, wherein the cracked mesh of silicon dioxide film comprises a crack density of 1×10⁸/m² to 1×10¹⁰/m² and a crack width from about 400 to 1000 nm.
